(19) United States
(12) Patent Application Publication
(10) Pub. No.: US 2016/0373180 A1
(43) Pub. Date: Dec. 22, 2016

(54) DOWNLINK BEAM DETERMINING METHOD, DEVICE AND SYSTEM, AND COMPUTER STORAGE MEDIUM

(71) Applicant: ZTE CORPORATION, Shenzhen, Guangdong (CN)

(72) Inventors: Senbao Guo, Shenzhen (CN); Guanghui Yu, Shenzhen (CN); Zhaohua Lu, Shenzhen (CN)

(21) Appl. No.: 15/106,465

(22) PCT Filed: Jun. 30, 2014
(86) PCT No.: PCT/CN2014/081287

§ 371 Date: Sep. 7, 2016

(30) Foreign Application Priority Data
Dec. 20, 2013 (CN) 201310714913.5

(51) Int. Cl. H04B 7/06; H04W 72/04

(52) U.S. Cl. CPC H04B 7/0695; H04W 72/042

(57) ABSTRACT

Downlink beam determination methods, devices and system and a computer storage medium are provided. One method includes that: at least one beam is sent, each beam respectively bearing a beam index corresponding to each beam; a fed-back beam index is received; and a beam corresponding to the fed-back beam index is selected as a downlink beam. Another method includes that: at least one beam is sent, each beam bearing a beam index corresponding to the each beam; a beam matching with a pre-stored beam selection strategy is selected from the received at least one beam; the beam index born on the selected beam is extracted; and the beam index is sent. A downlink beam determination method applied to a base station and a terminal, as well as the downlink beam determination device and system and the computer storage medium are also provided.

### TECHNICAL FIELD

The disclosure relates to a beam determination technology in the field of wireless communication, and in particular to downlink beam determination methods, devices and system and a computer storage medium.

### BACKGROUND

Beam Forming (BF) is a communication technology for Long Term Evolution (LTE) and LTE-advanced systems, which may change weights of antenna units of sending equipment to form directional beams in the space to reduce sending of signals in non-receiving directions, thereby reducing transmitting power, also improving or ensuring quality of received signals of a terminal, further reducing interference among the signals and improving system capacity.

An existing beam determination method includes that: first, a channel state is acquired; then, a BF weight is selected according to the channel state; and finally, a beam is formed according to the weight.

A process of acquiring the channel state includes that: a base station acquires downlink channel state information fed back by a terminal; and the terminal acquires uplink channel state information fed back by the base station. However, the base station may not send a signal to cover the terminal by virtue of an ideal beam before obtaining the BF weight, and the terminal may not receive or measure a reference signal sent by the base station, and may not feed back the channel state to the base station, so that it is impossible to implement BF, and the base station may not select a proper downlink beam to bear communication information.

### SUMMARY

In view of this, the embodiments of the disclosure provide downlink beam determination methods, devices and system and a computer storage medium, so as to solve the problem that it is impossible to implement beam communication by BF because of incapability in implementing BF on a downlink beam.

In order to achieve the purpose, the technical solutions of the embodiments of the disclosure are implemented as follows.

According to a first aspect of embodiments of the disclosure, a method for determining a downlink beam is provided, which may include that:

at least one beam is sent, wherein each of the at least one beam respectively bears a beam index corresponding to each of the at least one beam;

a fed-back beam index is received; and

a beam corresponding to the fed-back beam index is selected as a downlink beam.

Preferably, the method may further include that:

the beam index is born on the beam.

Preferably, the step that the beam index is born on the beam may include that:

a first sequence corresponding to the beam index is directly born on the beam;

or

a second sequence is pre-processed to form a third sequence by virtue of a first processing sequence, wherein the second sequence may include a system message sequence and/or a check sequence, the system message sequence may correspond to a system message, the check sequence may correspond to a check code of the system message, the first processing sequence may correspond to the beam index, the beam index may correspond to at least one first processing sequence and different beam indexes may correspond to different first processing sequences; and

the third sequence is born on the beam.

Preferably, the step that the first sequence corresponding to the beam index is directly born on the beam may include that:

the first sequence, corresponding to the beam index is born on the beam as a part of the system message sequence,

wherein the system message sequence may correspond to the system message.

Preferably, the first processing sequence may be a scrambling sequence; and

the step that the second sequence is pre-processed to form the third sequence by virtue of the first processing sequence may include that:

scrambling processing is performed on the system message sequence and/or the check sequence to form the third sequence by virtue of the scrambling sequence.

Preferably, the first processing sequence may be a spreading sequence; the second sequence may include the system message sequence and the check sequence; and

the step that the second sequence is pre-processed to form the third sequence by virtue of the first processing sequence may include that:

spreading processing is performed on the system message sequence and the check sequence to form the third sequence by virtue of the spreading sequence.

Preferably,

each of the at least one beam may respectively bear power indication information or power offset indication information of each of the at least one beam, wherein the power indication information or the power offset indication information may be configured to provide a basis for beam selection; and

before the step that the beam is sent, the method may further include that the power indication information or the power offset indication information is born on each of the at least one beam.

According to a second aspect of the embodiments of the disclosure, a method for determining a downlink beam is provided, which may include that:

at least one beam is received, wherein each of the at least one beam respectively bears a beam index corresponding to each of the at least one beam;

a beam matching with a pre-stored beam selection strategy is selected from the received at least one beam;

the beam index born on the selected beam is extracted; and

the beam index is sent.

Preferably, the step that the beam index is extracted may include that:

a first sequence corresponding to the beam index is directly extracted from the beam;

or

a third sequence is extracted from the beam;

preset processing is performed on the third sequence to acquire a second sequence by virtue of a second processing sequence which is pre-stored, the second sequence including a system message sequence and/or a check sequence, the system message sequence corresponding to a system message and the check sequence corresponding to a check code of the system message; and

the beam index is determined according to the second processing sequence corresponding to the second sequence obtained by preset processing,

wherein the second processing sequence may correspond to only one beam index, and the one beam index may correspond to at least one second processing sequence.

Preferably, the step that the first sequence corresponding to the beam index is directly extracted from the beam may include that:

the first sequence corresponding to the system message sequence is extracted from the beam,

wherein the system message sequence corresponds to the system message.

Preferably, the second processing sequence may be a descrambling sequence;

the step that preset processing is performed on the third sequence to acquire the second sequence by virtue of the second processing sequence which is pre-stored may include that:
descrambling processing is performed on the third sequence to acquire the second sequence by virtue of the descrambling sequence which is pre-stored; and

the step that the beam index is determined according to the second processing sequence corresponding to the second sequence obtained by preset processing may include that:
the beam index is determined according to the descrambling sequence corresponding to the second sequence obtained after descrambling processing.

Preferably, the second processing sequence may be a spreading sequence; the second sequence may include the system message sequence and the check sequence;

the step that preset processing is performed on the third sequence to acquire the second sequence by virtue of the second processing sequence which is pre-stored may include that:
de-spreading processing is performed on the third sequence to acquire the system message sequence by virtue of the spreading sequence which is pre-stored; and

the step that the beam index is determined according to the second processing sequence corresponding to the second sequence obtained by preset processing may include that:
the beam index is determined according to the spreading sequence corresponding to the second sequence obtained after de-spreading processing.

Preferably, the pre-stored beam selection strategy may be a strategy that received signal quality is optimal or a strategy that received signal quality is higher than a threshold value.

Preferably, the step that the beam matching with the pre-stored beam selection strategy is selected from the received at least one beam may include that:

power indication information or power offset indication information of the at least one beam is extracted from the at least one beam, and transmitting power of the at least one beam is acquired; and

when a received signal quality difference of at least two beams is smaller than a first threshold value or received quality of at least two beams is higher than a second threshold value, the beam with minimum transmitting power is selected.

According to a third aspect of the embodiments of the disclosure a method of determining a downlink beam is provided, which may include that:

a base station sends at least one beam, wherein each of the at least one beam respectively bears a beam index corresponding to each of the at least one beam;

a terminal receives the at least one beam;

the terminal selects a beam matching with a pre-stored beam selection strategy from the received at least one beam;

a beam index born on the selected beam is extracted;

the terminal sends the beam index to the base station; and

the base station receives the beam index, and selects the beam corresponding to the fed-back beam index as a downlink beam.

According to a fourth aspect of the embodiments of the disclosure, a device for determining a downlink beam is provided, which may include:

a first sending unit, configured to send at least one beam, wherein each of the at least one beam respectively bears a beam index corresponding to each of the at least one beam;

a first receiving unit, configured to receive a fed-back beam index; and

a first selection unit, configured to select a beam corresponding to the fed-back beam index as a downlink beam.

Preferably, the device may further include:

a bearing unit, configured to bear the beam index on the beam.

Preferably,

the bearing unit may specifically be configured to:

directly bear a first sequence corresponding to the beam index on the beam;

or

pre-process a second sequence to form a third sequence by virtue of a first processing sequence, wherein the second sequence may include a system message sequence and/or a check sequence, the system message sequence may correspond to a system message, the check sequence may correspond to a check code of the system message, the first processing sequence may correspond to the beam index, the beam index may correspond to at least one first processing sequence and different beam indexes may correspond to different first processing sequences; and

bear the third sequence on the beam.

Preferably, when the bearing unit is configured to directly bear the first sequence corresponding to the beam index on the beam, the bearing unit is configured to bear the first sequence, as a part of the system message sequence, corresponding to the beam index on the beam,

wherein the system message sequence corresponds to the system message.

Preferably, the first processing sequence is a scrambling sequence; and

the bearing unit may specifically be configured to perform scrambling processing on the system message sequence and/or the check sequence to form the third sequence by virtue of the scrambling sequence, and bear the third sequence on the beam.

Preferably, the first processing sequence may be a spreading sequence; the second sequence may include the system message sequence and the check sequence; and

the bearing unit may specifically be configured to perform spreading processing on the system message sequence and the check sequence to form the third sequence by virtue of the spreading sequence, and bear the third sequence on the beam.

Preferably,

each of the at least one beam respectively may bear power indication information or power offset indication information of each of the at least one beam;

the power indication information or the power offset indication information may be configured to provide a basis for beam selection; and

the bearing unit may further be configured to bear the power indication information or the power offset indication information on each of the at least one beam.

According to a fifth aspect of the embodiments of the disclosure, a device for determining a downlink beam, which may include:

a second receiving unit, configured to receive at least one beam, wherein each of the at least one beam respectively bears a beam index corresponding to each of the at least one beam;

a second selection unit, configured to select a beam matching with a pre-stored beam selection strategy from the received at least one beam;

an extraction unit, configured to extract a beam index born on the selected beam; and

a second sending unit, configured to send the beam index.

Preferably, the extraction unit may specifically be configured to:

directly extract a first sequence corresponding to the beam index from the beam;

or

extract a third sequence from the beam;

perform preset processing on the third sequence to acquire a second sequence by virtue of a second processing sequence which is pre-stored, the second sequence including a system message sequence and/or a check sequence, the system message sequence corresponding to a system message and the check sequence corresponding to a check code of the system message; and

determine the beam index according to the second processing sequence corresponding to the second sequence obtained by preset processing,

wherein the second processing sequence may correspond to only one beam index, and the one beam index may correspond to at least one second processing sequence.

Preferably, when the extraction unit is configured to directly extract the first sequence corresponding to the beam index from the beam, the extraction unit is configured to extract the first sequence corresponding to the system message sequence from the beam, the system message sequence corresponding to the system message.

Preferably, the second processing sequence may be a descrambling sequence; and

the extraction unit may specifically be configured to perform descrambling processing on the third sequence to acquire the second sequence by virtue of the descrambling sequence which is pre-stored, and determine the beam index according to the descrambling sequence corresponding to the second sequence obtained after descrambling processing.

Preferably, the second processing sequence may be a spreading sequence; the second sequence may include the system message sequence and the check sequence; and

the extraction unit may specifically be configured to perform de-spreading processing on the third sequence to acquire the second sequence by virtue of the spreading sequence which is pre-stored, and determine the beam index according to the spreading sequence corresponding to the second sequence obtained after de-spreading processing.

Preferably, the pre-stored beam selection strategy may be a strategy that received signal quality is optimal or a strategy that received signal quality is higher than a threshold value.

Preferably, the second selection unit may specifically be configured to extract, from the at least one beam, power indication information or power offset indication information of the at least one beam, acquire transmitting power of the beams, and when a received signal quality difference of at least two beams is smaller than a first threshold value or received quality of at least two beams is higher than a second threshold value, select the beam with minimum transmitting power.

According to a sixth aspect of the embodiments of the disclosure, a system for determining a downlink beam, which may include:

a base station, configured to send at least one beam, wherein each of the at least one beam respectively bears a beam index corresponding to each of the at least one beam, receive a beam index fed back by a terminal and select the beam corresponding to the beam index fed back by the terminal as a downlink beam; and

the terminal, configured to receive the at least one beam, select a beam matching with a pre-stored beam selection strategy from the received at least one beam, extract a beam index born on the selected beam, and send the beam index to the base station.

According to a seventh aspect of the embodiments of the disclosure, a computer storage medium is provided, in which computer-executable instructions may be stored,

the computer-executable instructions being configured to execute the abovementioned methods.

According to the downlink beam determination methods, devices and system and a computer storage medium in the embodiments of the disclosure, a base station sends multiple beams and determines a downlink beam according to a beam index received and fed back by the terminal, thereby solving the problem of incapability in implementing BF and thus the incapability in communication using a beam due to the fact that a terminal cannot feed back a channel state to the base station in a conventional art.

### BRIEF DESCRIPTION OF THE DRAWINGS

FIG. 1 is a flowchart of a downlink beam determination method according to a first embodiment of the disclosure;

FIG. 2 is a diagram of a mapping relationship among a beam, a time unit and a beam index according to a first embodiment of the disclosure;

FIG. 3 is a flowchart of a downlink beam determination method according to a second embodiment of the disclosure;

FIG. 4 is a flowchart of a downlink beam determination method according to a third embodiment of the disclosure;

FIG. 5 is a structure diagram of a downlink beam determination device according to a fourth embodiment of the disclosure; and

FIG. 6 is a structure diagram of a downlink beam determination device according to a fifth embodiment of the disclosure.

### DETAILED DESCRIPTION

The technical solutions of the disclosure will be further elaborated below with reference to the drawings of the specification and specific embodiments in detail.

### First Embodiment

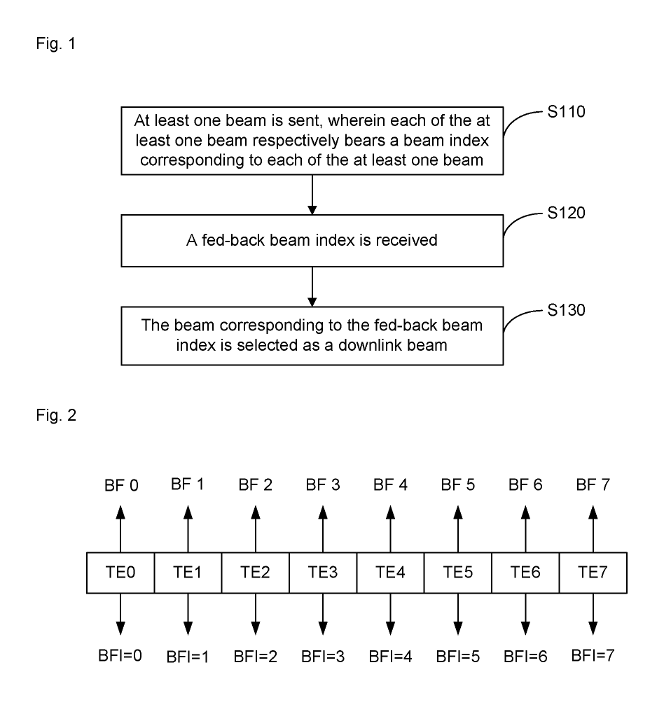

As shown in FIG. 1, the embodiment provides a downlink beam determination method, which includes:

Step 110: at least one beam is sent, wherein each of the at least one beam respectively bears a beam index corresponding to each of the at least one beam;

Step 120: a fed-back beam index is received; and

Step 130: a beam corresponding to the fed-back beam index is selected as a downlink beam.

The at least one beam in Step 110 is a beam subjected to BF processing, or may be a baseband beam, or may be a radio frequency beam. The multiple beams sent in Step 110 may point to the same sending direction, or may point to different sending directions. The multiple beams may be sent at the same time or may also be sent at different times as long as that a terminal may distinctively receive different beams. When a base station send the multiple beams in a code division multiplexing manner, a plurality of beams may be sent at the same time and the beam indexes of the beams may be processed in the code division multiplexing manner. Each beam corresponds to a beam index, the beams also bear the corresponding beam indexes, and after the terminal receives a beam, the beam index of the beam may be extracted from the beam. In Step 110, the multiple beams which are sent may be divided into a plurality of types, the beams of each type correspond to a BF weight, and the beams of the same type may adopt the same beam index.

After receiving multiple beams, a terminal may select a beam according to a beam selection strategy, extract the beam index in the beam and return the beam index to a beam sender (which is usually the base station) to facilitate beam selection and determination. When the terminal may extract the beam index from a beam, it is indicated that the beam has been received by the terminal and may be configured for communication between the base station and the terminal. Compared with an existing method, such a method is more convenient to implement, and the problem of incapability in receiving channel state information for BF is solved.

Specifically, for example, the base station may send N beams. The N beams cover all areas which are to be covered by the base station. A sending period of the base station is divided into M time units. Each time unit may further be divided into a plurality of timeslots corresponding to a plurality of frames or sub-frames. The M time units may further be divided into X time unit groups, and X is not smaller than 1, and is specifically, for example, 2, 3, 4 or 5. Each time unit group includes at least one time unit. A plurality of time units, configured to send beams, of the base station may be distributed in the sending period of the base station continuously or at intervals. For selected time unit groups or time units configured to send beams, a sub-frame offset and period combination manner may be adopted to indicate the time unit groups or time units configured to send beams. A sub-frame indicated by a sub-frame offset is a starting sub-frame, and a period is a sub-frame number between adjacent twice sending of beams.

As shown in FIG. 2, base station A may send 8 beams (that is, N=8); and the 8 beams may cover all areas which are to be covered by the base station. The 8 beams are sequentially BF0, BF1, BF2, BF3, BF4, BF5, BF6 and BF7, and sequentially correspond to beam indexes BFI=0, BFI=1, BFI=2, BFI=3, BFI=4, BFI=5, BFI=6 and BFI=7, wherein a sending period of the base station is divided into 8 time units (that is, M=8). The 8 time units are sequentially TE0, TE1, TE2, TE3, TE4, TE5, TE6 and TE7. Beam BF0 is sent at time unit TE0, beam BF1 is sent at time unit TE1, beam BF2 is sent at time unit TE2, beam BF3 is sent at time unit TE3, beam BF4 is sent at time unit TE4, beam BF5 is sent at time unit TE5, beam BF6 is sent at time unit TE6 and beam BF7 is sent at time unit TE7. In a specific implementation process, a beam index corresponds to a specific index value.

Base station A sends beams BF0, BF1, BF2, BF3, BF4, BF5, BF6 and BF7, and the base station receives one or more beams of them, and determines one of the received beams as a downlink beam according to a beam selection strategy. Here, the beam selection strategy is selecting a beam with optimal received quality and a beam which has received quality higher than a threshold value or the like, and the received quality may specifically be determined by a parameter such as a signal to noise ratio for evaluating a received signal quality effect.

After the beam is determined, the terminal extracts the beam index corresponding to the beam from the beam, and returns the extracted beam index to base station A. Specifically for example, terminal B receives beam BF2 and beam BF4 from the base station A, and determines beam BF4 as a downlink beam according to a strategy that the beam with optimal received quality is selected. The terminal B extracts beam index BFI=4 corresponding to beam BF4 from received beam BF4, and returns the beam index to the base station A, and the base station A may adopt beam BF4 when determining to communicate with the terminal B. A specific implementation process further includes a step of synchronization between the base station A and the terminal B. The synchronization between the base station A and the terminal B may be executed before the beams are sent or executed when the beams are sent. When synchronization is executed when the beams are sent, the synchronization method is to bear a synchronization sequence for synchronization with the terminal by virtue of the beam. Specifically for example, beam C is sent, and at the same time, a synchronization sequence for synchronization between the base station A and the terminal B is sent by virtue of beam C.

The beams sent in Step 110 may be configured to confirm the downlink beam only, and the beams may directly bear the beam indexes corresponding to the beams only. While in a specific implementation process, the beams may further be configured to bear other messages required to be sent to the terminal by the base station to reduce a beam sending frequency of the base station. Specifically for example, the beams may also bear system messages. The system messages are usually communication-related announcements, notices, prompts or the like sent to user equipment by a device such as a network manager or a base station in a broadcasting manner, provide necessary conditions for communication, and may specifically include at least one of the following information: system control signalling, radio frame numbers (configured to indicate radio frames born by the control signalling), bandwidths, Public Land Mobile Network (PLMN) numbers and the like.

Before the beams are sent, the downlink beam determination method of the embodiment further includes that the beam index is born on the beam.

There are many bearing methods.

Method 1: a first sequence corresponding to the beam index is directly born on the beam; and the first sequence may be independently born on the beam, or may be born on the beam together with other message sequence sent to the terminal by the base station. Specifically for example, the beam is further configured to bear a system message, the beam index serves as a part of the system message, and the first sequence and message sequences corresponding to other parts of the system message are born on the beam respectively.

Method 2: a method for indirectly bearing the beam index on the beam includes that:

a second sequence is pre-processed to form a third sequence by virtue of a first processing sequence, wherein the second sequence includes a system message sequence and/or a check sequence, the system message sequence corresponds to the system message, the check sequence correspond to a check code for implementing error verification and verification on the system message, the check sequence may be any check code sequence, and is preferably a Cyclic Redundancy Check (CRC) sequence in the embodiment, the first processing sequence corresponds to the beam index, the beam index corresponds to at least one first processing sequence, different beam indexes correspond to different first processing sequences, and each beam index may correspond to one, two or more than two first processing sequences; and

the third sequence is born on the beam.

The check sequence is transmitted together with the system message, so that the beam bears both the beam index and the system message in the embodiment. The beam index is coupled into at least one of the system message sequence and the check sequence of the system message sequence, so that a length of the sequence born on the beam is reduced, and signalling overhead is reduced.

When the first sequence is directly born on the beam in the first method, log₂ N bits may be adopted to represent the index beam, wherein N is the total number of beams which may be sent by the base station. For example, for 8 beams, 3 bits may be adopted for representation, and each of 000, 001, 010, 011, 100, 101, 110 and 111 corresponds to a beam.

The bits may be born on the beams as parts of system message bits corresponding to the system messages.

In the second method, there are many manners for indirectly bearing the beam indexes on the beams, and some convenient implementation manners are specifically provided below.

Manner A: the first processing sequence is a scrambling sequence; and

the operation that the second sequence is pre-processed to form the third sequence by virtue of the first processing sequence includes that:

scrambling processing is performed on the second sequence to form the third sequence by virtue of the scrambling sequence.

The length of the scrambling sequence is equal to length of the second sequence; when the second sequence includes the system message sequence only, the length of the scrambling sequence is equal to length of the system message sequence; when the second sequence includes the check sequence only, the length of the scrambling sequence is equal to length of the check sequence of the system messages; and when the second sequence includes both the system message sequence and the check sequence, the length of the scrambling sequence is equal to the length of the system message sequence and the length of the check sequence.

In a condition that the second sequence includes the check sequence of the system message sequence and the check sequence of the system message sequence is a CRC check sequences, the scrambling sequence is a CRC scrambling sequence.

If base station C may send 16 beams, the 16 beams may cover all areas to be covered by the base station C. There are at least 16 scrambling sequences for the base station C to perform scrambling processing on system messages. Different beams correspond to different scrambling sequences, so that different scrambling sequences may correspond to the same beam indexes. After the terminal receives the beams, third sequences are extracted from the beams, and descrambling sequences corresponding to the scrambling sequences are adopted for descrambling. In case of successful descrambling, receiving equipment (such as the terminal) obtains second sequences corresponding to the system messages, and determines the beam indexes according to a corresponding relationship between the descrambling sequences and the scrambling sequences. The scrambling sequences may be various types of scrambling sequences.

Manner B: the processing sequences are spreading sequences; and

the operation that the second sequences corresponding to the system messages are pre-processed to form the third sequences by virtue of the processing sequences includes that: the second sequences include system message sequences and the check sequences of the system message sequences,

spreading processing is performed on the second sequences to form the third sequences by virtue of the spreading sequences.

Spreading processing is spectrum spreading on transmitted information using sequences unrelated to the transmitted information for ensuring occupation of a bandwidth larger than a minimum bandwidth needed for the transmitted information. The transmitted information in the embodiment is system messages, and signals transmitted after spreading processing have the advantages of high capabilities in resisting interference, multipath fading and the like.

In a specific implementation process, any two spreading sequences may be orthogonal, so that interference among the third sequences formed by processing the second sequences subjected to different spreading sequences is avoided, the receiver may receive multiple beams at the same time, and a plurality of beams are sent at the same time to shorten the time for determining a downlink beam.

When the second manner for bearing a beam index on a beam is adopted, the sequences, such as scrambling sequences and spreading sequences, adopted for existing communication, are adopted to indicate corresponding beams, so that signalling overhead is reduced, and convenience for implementation is ensured.

As a further improvement of the embodiment, the beam further bears power indication information or power offset indication information of the beam; and before the beam is sent, the method further includes that the power indication information or the power offset indication information is born on the beam.

The power indication information usually includes an absolute value of transmitting power of the beam, the power offset indication information usually includes a relative value of the transmitting power of the beam, and both of them may be configured to indicate transmitting power of a current beam. The power indication information or the power offset indication information is configured to provide a basis for beam selection of the receiver (such as the terminal). Specifically, for example, when the terminal receives a plurality of beams, received quality of multiple beams therein is high or the received quality is poor and lower than a threshold value, the terminal may select a beam with lower transmitting power for communication, so that the transmitting power of the base station is reduced on one hand, and radiation pollution caused by communication is reduced on the other hand. In a specific implementation process, the sequence, as a part of the second sequence, corresponding to the power indication information and the power offset indication information may also be subjected to scrambling or spreading processing.

The embodiment provides the downlink beam determination method, which conveniently solves the problem of incapability in implementing BF due to the fact that the terminal cannot return the channel state in the conventional art.

### Second Embodiment

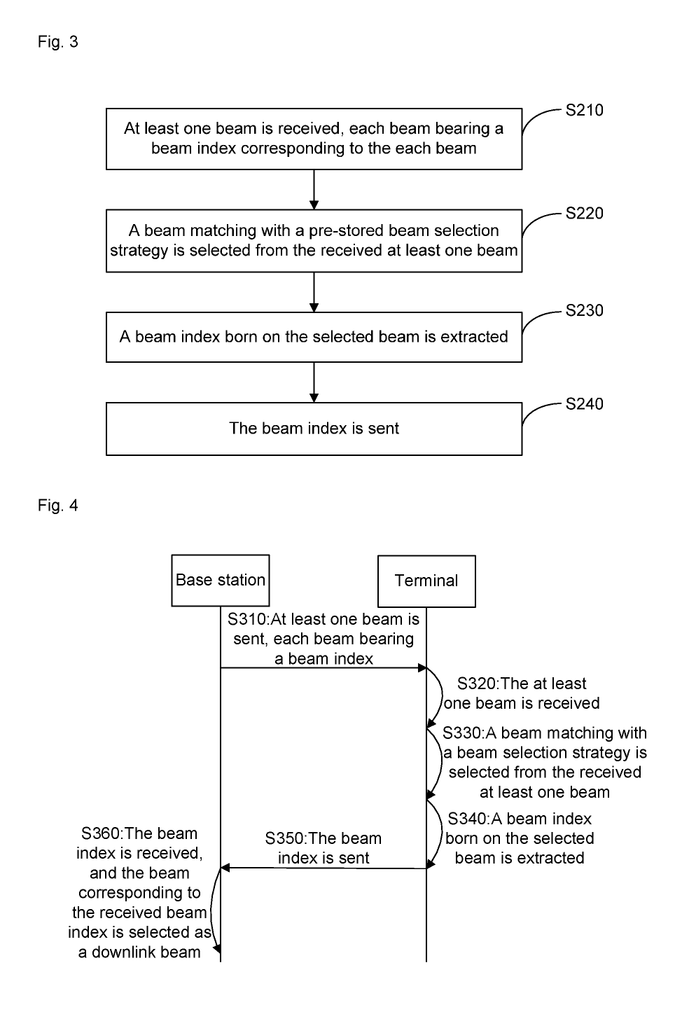

As shown in FIG. 3, the embodiment provides a downlink beam determination method, which includes:

Step S210: at least one beam is received, each of the at least one beam bearing a beam index corresponding to each of the at least one beam;

Step S220: a beam matching with a pre-stored beam selection strategy is selected from the received at least one beam;

Step S230: the beam index born on the selected beam is extracted; and

Step S240: the beam index is sent.

The downlink beam determination method of the embodiment is proposed for a terminal side, and corresponds to the downlink beam determination method proposed for a base station side or a network side in the first embodiment.

In Step S210, a receiver (such as a terminal) receives a plurality of beams at the same time or different times in a specified time unit or time unit group, or may also receive one beam only. The time unit and/or time unit group for sending the beams is negotiated by the terminal and a base station in advance, or is acquired by the base station in a blind detection manner or is notified to the receiver by a sender (such as the base station) through a system message, and the like.

When the receiver receives a plurality of beams, the terminal selects a beam as a downlink beam according to a pre-stored beam selection strategy. Specifically for example, the receiver (such as a mobile phone) receives a first beam, a second beam and a third beam; and if the second beam is a beam matching with the pre-stored beam selection strategy, the second beam is selected in Step S220. Then, a beam index is extracted from the second beam by Step S230, and the beam index of the second beam is sent to notify the sender (such as the base station) of the selected beam index for the base station to select the second beam as the downlink beam.

When the receiver receives only one beam, the beam may be directly selected as the downlink beam, and whether the beam serving as the downlink beam may provide needed communication quality or not may further be determined by Step S220. Specifically for example, if the beam selection strategy in Step S220 is a strategy that received quality is higher than a threshold value, when the received quality of the received beam in the receiver is lower than the threshold value, it is indicated that the communication quality is poor, and the received beam may not be selected as the beam for communication.

There are many pre-stored beam selection strategies, specifically including a strategy that received signal quality is optimal or a strategy that the received signal quality is higher than a threshold value.

When the strategy that the received signal quality is optimal, received quality of each beam which may be received by the terminal in the terminal is compared in Step S220, and then the beam with optimal received quality is selected. There may be one or more parameters configured to evaluate the received quality, specifically such as a signal to noise ratio. When the strategy is adopted, communication quality between the base station and the terminal may be improved as much as possible.

Under a condition that the strategy that the received signal quality is higher than the threshold value, when the received quality of a certain received beam in the terminal is higher than the preset threshold value, subsequent beam reception may be neglected in Step S220, so that the downlink beam may be determined fast.

The specific beam selection strategy to be selected may be determined according to a communication requirement and a channel state.

Different methods for extracting a beam index in Step S230 may be adopted according to different manners for bearing a beam indexes in a beam, and specifically include the followings.

First: a first sequence of a beam index is directly extracted from a beam. The beam index is usually born on the beam independently or together with another message transmitted to the terminal such as a system message, and the receiver (such as a mobile phone) is only needed to extract the beam index from a corresponding position of the beam. Such a manner is convenient and easy. Specifically for example, the beam index serves as a part of the system message, and the first sequence is extracted from the beam as a part of a system message sequence corresponding to the system message.

Second: a manner of indirectly extracting a beam index from a beam:

a third sequence is extracted from the beam;

preset processing is performed on the third sequence to acquire a second sequence by virtue of a second processing sequence which is pre-stored, wherein the second sequence includes at least one of a system message sequence and a check sequence, the system message sequence corresponds to the system message and the check sequence corresponds to a check code of the system message; and

the beam index is determined according to the second processing sequence corresponding to the second sequence obtained by preset processing.

The second processing sequence may be a descrambling sequence, or may be a processing sequence such as a spreading sequence configured for de-spreading processing. There are usually a plurality of processing sequences stored in the terminal, the terminal may perform preset processing on the third sequence by virtue of the second processing sequences one by one, and if the third sequence is successfully processed to obtain the second sequence by virtue of sequence a in the second sequence, the beam index is determined according to the sequence a. After the sequence a is determined, a first processing sequence corresponding to the sequence a is determined, and the beam index may be successfully obtained according to a mapping relationship between a first processing sequence and a beam index. One second processing sequence corresponds to only one beam index, and one beam index may correspond to one or more second processing sequences.

Specifically, when the second processing sequence is a descrambling sequence,

at first, descrambling processing is performed on the third sequence to acquire the second sequence by virtue of the descrambling sequence which is pre-stored; and

then, an index of the corresponding descrambling sequence corresponding to the second sequence obtained by descrambling processing is determined as the beam index.

When the second sequence is the check sequence of the system message sequence, the descrambling sequence is a check code descrambling sequence. If the check sequence of the system message sequence is a CRC sequence corresponding to a CRC, the descrambling sequence is a CRC descrambling sequence.

After receiving a beam, the terminal usually performs descrambling processing on a third sequence born on the beam sequentially by virtue of a plurality of descrambling sequences which are pre-stored. In case of successful descrambling, a second sequence is obtained, the descrambling sequence is determined, a scrambling sequence is also determined, and a beam index corresponding to the beam is determined. Whether descrambling succeeds or not may be determined by adopting any existing method, and specifically for example, a check code is adopted for determination and whether the number of 0 or 1 in the decoded second sequence meets a preset requirement or not is determined.

Specifically, when the second processing sequence is a spreading sequence,

at first, de-spreading processing is performed on the third sequence to acquire the second sequence by virtue of the spreading sequence which is pre-stored, the second sequence including the system message sequence and the check sequence, the system message sequence corresponding to the system message and the check sequence corresponding to the check code of the system message; and

then, the beam index is determined according to the corresponding spreading sequence corresponding to the second sequence obtained after de-spreading processing.

After receiving a beam, the terminal usually performs de-spreading processing on a third sequence born on the beam sequentially by virtue of a plurality of descrambling sequences which are pre-stored. In case of successful de-spreading, a second sequence is obtained, a spreading sequence is determined, a spreading sequence for spreading processing in the base station is also determined, and a beam index corresponding to the beam is further determined. Whether de-spreading succeeds or not may be determined by adopting any existing method, and specifically for example, a check code is adopted for determination and whether the number of 0 or 1 in the decoded second sequence meets a preset requirement or not is determined.

In addition, the embodiment of the disclosure further provides a different downlink beam determination method, specifically includes:

Step 1: power indication information or power offset indication information of the at least one beam is extracted from the at least one beam to acquire transmitting power of the at least one beam, wherein the power indication information and the power offset indication information both bear the transmitting power of the at least one beam received by the terminal; and

Step 2: when received signal quality of at least two beams is higher than a second threshold value or a difference between received quality is smaller than a first threshold value, the beam with minimum transmitting power is selected, both the first threshold value and the second threshold value is pre-stored.

When the beam is determined by the method, communication quality of the terminal may be ensured to a certain extent, transmitting power of the base station may also be reduced as much as possible, and power consumption of the base station and communication radiation pollution are reduced.

The downlink beam determination method of the embodiment is different from an existing method for determining a downlink beam by sending and receiving a reference signal between the terminal and the base station, the beams are directly sent in the embodiment, and the downlink beam is determined by virtue of the beam selection strategies, such as whether the terminal receives the beam or not and whether the beam meets a requirement of the terminal on received quality or not, so that the problem of incapability in implementing communication by virtue of a beam due to the fact that a BF weight may not be determined is solved.

### Third Embodiment

As shown in FIG. 4, the embodiment provides a downlink beam determination method, which includes:

Step S310: a base station sends at least one beam, wherein each of the at least one beam respectively bears a beam index corresponding to each of the at least one beam;

Step S320: a terminal receives the at least one beam;

Step S330: the terminal selects a beam matching with a pre-stored beam selection strategy from the received at least one beam;

Step S340: a beam index born on the selected beam is extracted;

Step S350: the terminal sends the beam index to the base station; and

Step S360: the base station receives the beam index, and selects the beam corresponding to the fed-back beam index as a downlink beam.

The beams in Step S310 may be baseband beams, or may be radio frequency beams, and the selection of a manner may be determined according to a communication system structure and a communication requirement. Sending directions and sending time of the beams may be the same or different as long as a respective receiving requirement of the terminal is met.

In Step S320, the terminal may receive one or more beams. The beam selection strategy may be the beam selection strategy in the first embodiment and the second embodiment.

In Step S340, different manners for the terminal to extract the beam index from the beam may be adopted according to different manners for bearing beam indexes on beams. Specifically for example, a first sequence corresponding to the beam index is directly extracted from the beam, and a system message sequence and/or a check sequence may also be extracted to acquire the beam index, specifically referring to the second embodiment.

By the downlink beam determination method of the embodiment, the downlink beam may be determined conveniently and fast, and the problem of incapability in implementing communication by virtue of a beam due to the fact that a BF weight may not be determined in the conventional art is solved.

### Fourth Embodiment

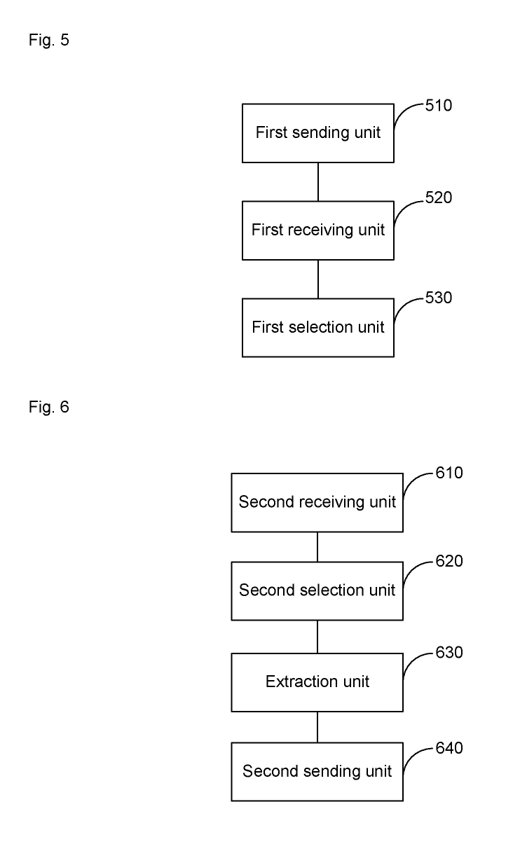

The embodiment provides a downlink beam determination device, and as shown in FIG. 5, the device includes:

a first sending unit 510, configured to send at least one beam, wherein each of the at least one beam respectively bears a beam index corresponding to each of the at least one beam;

a first receiving unit 520, configured to receive a fed-back beam index; and

a first selection unit 530, configured to select a beam corresponding to the fed-back beam index as a downlink beam.

The first sending unit 510 has a specific structure which may be a sending antenna or a sending antenna array, specifically such as an intelligent antenna array, and is configured to send beams subjected to BF processing with different weights, each beam bearing the corresponding beam index.

The first receiving unit 520 may be an air interface structure such as a receiving antenna, and is configured to receive the beam index sent by a terminal.

The second selection unit 530 is configured to determine the downlink beam according to the beam index received by the first receiving unit 520.

As a further improvement of the embodiment, the device of the embodiment further includes an additional bearing unit configured to bear the beam index on the beam on the basis of the above structure. The bearing unit may have three structures according to different bearing methods.

First: the bearing unit is specifically configured to directly bear a first sequence corresponding to the beam index on the beam. Specifically for example, the bearing unit is specifically configured to bear the first sequence corresponding to the beam index on the beam as a part of a system message sequence corresponding to a system message. The first sequence is usually converted from the beam index, and different beam indexes correspond to different first sequences.

Second: a second sequence is pre-processed to form a third sequence by virtue of a first processing sequence, and the third sequence is born on the beam, the second sequence including at least one of the system message sequence and check sequence. The system message sequence corresponds to the system message, and the check sequence corresponds to a check code of the system message.

Here, a specific structure of the bearing unit includes a physical structure such as a demodulation circuit.

The first structure of the bearing unit has the advantages of simplicity and high speed in implementation; and the second bearing structure reduces the time of sending a beam from the base station to the terminal and also reduces the sequence length, thereby reducing signalling overhead.

There are multiple bearing unit structures corresponding to the second bearing method, and two are provided below.

First: the processing sequence is a scrambling sequence, and the bearing unit includes a scrambling module; and the scrambling module performs scrambling processing on the system message sequence and/or the check sequence to form the third sequence by virtue of the scrambling sequence. A physical structure of the scrambling module may be a scrambling circuit or a scrambler.

Second: the processing sequence is a spreading sequence; the bearing unit includes a spreading module;

the spreading unit is specifically configured to perform spreading processing on the system message sequence and the check sequence to form the third sequence by virtue of the spreading sequence. The spreading unit may adopt any existing spreading structure, and may specifically be a spreading circuit, a spreader and the like.

As a further improvement of the embodiment, each beam further bears power indication information or power offset indication information of the beam; the power indication information or the power offset indication information is configured to provide a basis for beam selection; and

the bearing unit is further configured to bear the power indication information or the power offset indication information on each of the at least one beam. Specifically for example, the bearing unit bears the power indication information or the power offset indication information on the beam as a part of the system message.

The embodiment further provides an example of the downlink beam determination device; and the device specifically includes one or more processors, a storage medium, at least one communication interface and a bus which connects the processors, the storage medium and the communication interface. The communication interface is configured to send and receive data to implement data interaction with external equipment. The storage medium stores software or firmware; and the storage medium may be a common storage medium such as a Read-Only Memory (ROM), a Random Access Memory (RAM) and a Flash, and is preferably a non-transient storage medium such as a ROM and a compact disc.

The processors run the software or the firmware, and the downlink beam determination device may at least realize the following functions of:

sending at least one beam, wherein each of the at least one beam respectively bears a beam index corresponding to each of the at least one beam;

receiving a fed-back beam index; and

selecting a beam corresponding to the fed-back beam index as a downlink beam.

From the above, the downlink beam determination device of the embodiment provides specific implementation hardware for the downlink beam determination method in the first embodiment of the disclosure, has the advantage that the downlink beam may be determined conveniently, and solves the problem that it is impossible to implement BF for beam communication because of incapability in acquiring channel state information.

### Fifth Embodiment

As shown in FIG. 6, the embodiment provides a downlink beam determination device, which further includes:

a second receiving unit 610, configured to receive at least one beam, wherein each of the at least one beam respectively bears a beam index corresponding to each of the at least one beam;

a second selection unit 620, configured to select a beam matching with a pre-stored beam selection strategy from the received at least one beam;

an extraction unit 630, configured to extract a beam index born on the selected beam; and

a second sending unit 640, configured to send the beam index.

The second receiving unit 610 has a specific structure which may be a receiving device such as a receiving antenna, and is configured to receive the at least one beam sent by a sender (such as a base station).

The second selection unit 620 selects a beam according to the pre-stored beam selection strategy, determines the selected beam as a downlink beam, and has a specific structure including one or more processors; and when the processors run, the beam matching with the beam selection strategy may be selected from the beams received by the second receiving unit 610. The processors may be Central Processing Units (CPUs), single-chip microcomputers, digital processors, programmable logic array processors and the like. There are multiple beam selection strategies, and two preferred strategies are provided in the embodiment, specifically a strategy that received signal quality is optimal and a strategy that the received signal quality is higher than a threshold value.

In order to further notify the sender of the beams, the extraction unit 630 extracts the beam index of the selected beam from the selected beam, and sends the extracted beam index to the sender (which is usually the base station). The extraction unit 630 has a specific structure which may be a demodulator or a demodulation, and is configured to extract a sequence born on the selected beam from the beam, thereby acquiring the beam index.

A specific structure of the second sending unit 640 may be a structure such as a sending antenna.

The downlink beam determination device of the embodiment may be an independent structure, and is preferably a structure integrated in a communication terminal. The communication terminal may specifically be a physical communication device such as a mobile phone and an intelligent mobile phone.

The downlink beam determination device of the embodiment receives beams, selects a beam and sends a beam index to implement downlink beam selection. Compared with an existing method, the device here has the advantages of selecting a beam fast and conveniently and avoiding the phenomenon that beam communication cannot be implemented due to the fact that the base station cannot interact with a terminal about channel state information.

In a specific implementation process, the extraction unit may adopt multiple manners for extracting a beam index, and correspondingly has multiple physical structures.

First: the extraction unit directly extracts a first sequence corresponding to the beam index from the beam. The extraction unit directly extracts the first sequence from the beam or extracts the born first sequence corresponding to a system message sequence of a system message from the beam; and the first sequence may be configured to indicate the beam index corresponding to the beam, and may also be configured to indicate other information. Different beams correspond to different beam indexes. The beam indexes may be distinguished by index values; and the first sequence may be converted from the index value. In the embodiment, the first sequence serves as a part of the system message sequence corresponding to the system message.

Second: the extraction unit extracts a third encoding sequence corresponding to the system message from the beam, then performs preset processing on the third sequence to acquire a second sequence corresponding to the system message by virtue of a second processing sequence which is pre-stored, and finally determines an index of the second processing sequence corresponding to the second sequence obtained after preset processing as the beam index.

Specifically, when the second structure is adopted, there exist multiple conditions, and two specific implementation manners are provided below.

Manner 1: the extraction unit includes a first acquisition module and a descrambling module;

the first acquisition module is configured to demodulate the third sequence from the beam; and

the descrambling module is specifically configured to perform descrambling processing on the third sequence to acquire the second sequence corresponding to the system message by virtue of a descrambling sequence which is pre-stored, and

determine an index of the descrambling sequence corresponding to the second sequence obtained after descrambling processing as the beam index.

Manner 2: the second processing sequence is a spreading sequence;

the extraction unit includes a second acquisition module and a de-spreading module;

the second acquisition module is configured to extract the third sequence from the beam, wherein the extraction includes demodulation and the like, and the demodulation corresponds to specific physical hardware such as a demodulation circuit or a demodulator; and

the de-spreading module is configured to perform de-spreading processing on the third sequence to acquire the second sequence corresponding to the system message by virtue of the spreading sequence which is pre-stored, and

determine index information of the spreading sequence corresponding to the second sequence obtained after de-spreading processing as the beam index.

Both the first acquisition module and the second acquisition module may be physical structures such as demodulators or demodulation circuits. A specific structure of the descrambling module may be a descrambler or a descrambling circuit. A specific structure of the de-spreading module may be a de-spreader or a de-spreading circuit.

When the beam also bear power indication information or power offset indication information of the beam, the second selection unit specifically includes a third acquisition module and a beam index determination module. The third acquisition module is configured to demodulate the power indication information or power offset indication information of the beam from the beam to acquire transmitting power of the beam. The beam index determination module is configured to, when received signal quality of at least two beams is equal or higher than a first threshold value or a difference between received signal quality is lower than a second threshold value, select a beam with minimum transmitting power. In the embodiment, the received quality in the terminal is ensured, and in addition, the beam with lower transmitting power is selected, so that transmitting power of the sender (such as the base station) is reduced, and beam radiation pollution in communication is also reduced.

The downlink beam determination device of the embodiment is configured to select and determine the downlink beam, has the advantages of convenience and high speed in selection, and may effectively solve the problem that the base station and the terminal may not implement interaction about a channel state so as not to continue communication by virtue of a beam.

The embodiment further provides an example of the downlink beam determination device; and the device specifically includes one or more processors, a storage medium, at least one communication interface and a bus which connects the processors, the storage medium and the communication interface. The communication interface is configured to send and receive data to implement data interaction with external equipment. The storage medium stores software or firmware; and the storage medium may be a common storage medium such as a ROM, and is preferably a power-off storage medium.

The processors run the software or the firmware, and the downlink beam determination device may at least realize the following functions of:

receiving at least one beam, each of the at least one beam bearing a beam index corresponding to each of the at least one beam;

selecting a beam matching with a pre-stored beam selection strategy from the received at least one beam;

extracting a beam index born on the selected beam; and

sending the beam index.

From the above, the downlink beam determination device of the embodiment provides specific implementation hardware for the downlink beam determination method in the second embodiment of the disclosure, and may effectively solve the problem of incapability in implementing BF for beam communication due to the fact that channel state information may not be acquired.

### Sixth Embodiment

The embodiment of the disclosure provides a downlink beam determination system, which includes:

a base station, configured to send at least one beam, wherein each of the at least one beam respectively bears a beam index corresponding to each of the at least one beam, receive a beam index fed back by a terminal and select a beam corresponding to the beam index fed back by the terminal as a downlink beam; and

the terminal, configured to receive the at least one beam, select a beam matching with a pre-stored beam selection strategy from the received at least one beam, extract a beam index born on the selected beam, and send the beam index to the base station.

The downlink beam determination system of the embodiment includes the base station and the terminal, and the beam is selected and determined from the at least one beam formed by BF processing between the base station and the terminal, so that the problem that a BF weight may not be obtained for further implementing BF due to the fact that a reference signal sent by the base station cannot arrive at the terminal or the terminal cannot return a channel state in the conventional art may be effectively solved.

The base station in the embodiment corresponds to any structure of the device in the fourth embodiment; and the terminal corresponds to any structure of the device in the fifth embodiment.

Application examples 1-4 based on the downlink beam determination methods, downlink beam determination devices and downlink beam determination system of the embodiment of the disclosure will be provided below.

### Example 1

Example 1 includes sub-examples 1.1-1.9.

It is supposed that a base station may substantially cover an area that is to be covered by the base station by virtue of N beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal N−1 and system message N−1 by virtue of beam N−1 at time unit N−1 or time unit group N−1, wherein different synchronization signals may have the same sequence or different sequences. System message n (n=0, 1, . . . , N−1) bears an index of the corresponding beam, and the base station indicates a corresponding beam index by virtue of M (0≦M≦log₂(N)) bits in a system message, wherein N is a predefined maximum number of beams supported by the base station.

A terminal detects synchronization signals and/or the system messages at each time unit, and the terminal detects multiple time units to obtain one or more groups of beam indexes capable of optimizing receiving performance of the terminal or ensuring optimal received signal quality, and feeds back corresponding beam indexes to the base station. If the terminal has optimal performance when performing detection at time unit 1, the terminal may detect system message 1 to obtain the corresponding beam index and directly or indirectly feed back an index value of the corresponding beam index to the base station through an uplink. The beam indexes form a certain corresponding relationship with CRC scrambling bit sequence indexes, scrambling code indexes and spreading code indexes in the sub-examples.

### Sub-Example 1.1

It is supposed that the base station may substantially cover an area to be covered by the base station by virtue of 8 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 7 and system message 7 by virtue of beam 7 at time unit 7 or time unit group 7, wherein different synchronization signals may have the same sequence or different sequences. System message n (n=0, 1, . . . , 7) bears an index of a corresponding beam, and the base station indicates the corresponding beam index by virtue of 3 bits in the system message, wherein 8 is the predefined maximum number of beams supported by the base station.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back a corresponding beam index to the base station. If the terminal has optimal performance when performing detection at time unit 1, the terminal may detect bits of system message 1 to obtain beam index value 1 and directly or indirectly feed back the beam index value to the base station through the uplink.

### Sub-Example 1.2

It is supposed that the base station may substantially cover an area to be covered by the base station by virtue of 4 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 3 and system message 3 by virtue of beam 3 at time unit 3 or time unit group 3, wherein different synchronization signals may have the same sequence or different sequences. System message n (n=0, 1, . . . , 3) bears an index of a corresponding beam, and the base station indicates a corresponding beam index by virtue of 3 bits in the system message, wherein 2³=8 is the predefined maximum number of beams supported by the base station.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal has optimal performance when performing detection at time unit 1, the terminal may detect 3 bits of system message 1 to obtain beam index value 1 and feed back the beam index value to the base station directly or indirectly through the uplink.

### Sub-Example 1.3

It is supposed that the base station may substantially cover an area to be covered by the base station by virtue of 8 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 7 and system message 7 by virtue of beam 7 at time unit 7 or time unit group 7, wherein different synchronization signals may have the same sequence or different sequences. System message n (n=0, 1, . . . , 7) bears an index of a corresponding beam, and the base station indicates a corresponding beam index by virtue of a CRC scrambling bit sequence in a system message. Here, there are predefined 8 CRC scrambling bit sequences, and each sequence corresponds to a beam index, as shown in Table 1. Each CRC scrambling bit sequence may preferably be a sequence which has a length of 16 and consists of a plurality of elements “0” and “1”. Table 1 shows a corresponding relationship between a beam index and a CRC scrambling bit sequence. The CRC scrambling bit sequence corresponds to the scrambling sequence in the first embodiment to the sixth embodiment.

TABLE 1

| Beam index | CRC scrambling bit sequence |
|---|---|
| Beam index 0 | CRC scrambling bit sequence 0 |
| Beam index 1 | CRC scrambling bit sequence 1 |
| Beam index 2 | CRC scrambling bit sequence 2 |
| Beam index 3 | CRC scrambling bit sequence 3 |
| Beam index 4 | CRC scrambling bit sequence 4 |
| Beam index 5 | CRC scrambling bit sequence 5 |
| Beam index 6 | CRC scrambling bit sequence 6 |
| Beam index 7 | CRC scrambling bit sequence 7 |

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back a corresponding beam index to the base station. If the terminal has optimal performance when performing detection at time unit 1, the terminal may detect CRC scrambling bits of system message 1 to obtain an index of a CRC scrambling bit sequence or beam index value 1 and directly or indirectly feed back the index of a CRC scrambling bit sequence or the beam index value to the base station through the uplink. At this moment, an index of a CRC scrambling bit sequence corresponds to a beam index. The CRC scrambling bit sequence is configured to scramble a CRC bit sequence of the system message.

### Sub-Example 1.4

It is supposed that the base station may substantially cover an area to be covered by the base station by virtue of 4 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 3 and system message 3 by virtue of beam 3 at time unit 3 or time unit group 3, wherein different synchronization signals may have the same sequence or different sequences. System message n (n=0, 1, . . . , 3) bears an index of a corresponding beam, and the base station indicates corresponding beam indexes by virtue of CRC scrambling bit sequences in the system messages. Here, there are predefined 8 CRC scrambling bit sequences, and each sequence corresponds to a beam index, as shown in Table 2. Each CRC scrambling bit sequence may preferably be a sequence which has a length of 16 and consists of a plurality of elements “0” and “1”.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal has optimal performance when performing detection at time unit 1, the terminal may detect the CRC scrambling bit sequence of system message 1 to obtain an index of a CRC scrambling bit sequence or beam index value 1 and directly or indirectly feed back the index of a CRC scrambling bit sequence or the beam index value to the base station through the uplink. At this moment, the index of a CRC scrambling bit sequence corresponds to the beam index.

The CRC scrambling bit sequence is configured to scramble a CRC bit sequence of the system message.

### Sub-Example 1.5

It is supposed that the base station may substantially cover an area to be covered by the base station by virtue of 8 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 7 and system message 7 by virtue of beam 7 at time unit 7 or time unit group 7, wherein different synchronization signals may have the same sequence or different sequences. System message n (n=0, 1, . . . , 7) bears an index of a corresponding beam, and the base station indicates the corresponding beam indexes by virtue of scrambling bit sequences in the system messages. Here, there are predefined 8 scrambling bit sequences, and each sequence corresponds to a beam index, as shown in Table 2. A length of each scrambling bit sequence may preferably be a length of a system information bit sequence, and may include or may not include the length of a CRC bit sequence. Table 2 shows a corresponding relationship between a beam index and a scrambling bit sequence. The scrambling bit sequence corresponds to the scrambling sequence in the first embodiment to the sixth embodiment.

TABLE 2

| Beam index | Scrambling bit sequence |
|---|---|
| Beam index 0 | Scrambling bit sequence 0 |
| Beam index 1 | Scrambling bit sequence 1 |
| Beam index 2 | Scrambling bit sequence 2 |
| Beam index 3 | Scrambling bit sequence 3 |
| Beam index 4 | Scrambling bit sequence 4 |
| Beam index 5 | Scrambling bit sequence 5 |
| Beam index 6 | Scrambling bit sequence 6 |
| Beam index 7 | Scrambling bit sequence 7 |

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal has optimal performance when performing detection at time unit 1, the terminal may detect scrambling bits of system message 1 to obtain a scrambling bit sequence index or beam index value 1 and directly or indirectly feed back the scrambling bit sequence index or the beam index value to the base station through the uplink. At this moment, the scrambling bit sequence index corresponds to the beam index. The scrambling bit sequence is configured to scramble and descramble the system message.

### Sub-Example 1.6

It is supposed that the base station may substantially cover an area to be covered by the base station by virtue of 4 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 3 and system message 3 by virtue of beam 3 at time unit 3 or time unit group 3, wherein different synchronization signals may have the same sequence or different sequences. System message n (n=0, 1, . . . , 3) bears an index of a corresponding beam, and the base station indicates the corresponding beam indexes by virtue of scrambling bit sequences in the system messages. Here, there are predefined 8 scrambling bit sequences, and each sequence corresponds to a beam index, as shown in Table 3. A length of each scrambling bit sequence may preferably be a length of a system information bit sequence, and may include or may not include the length of a CRC bit sequence.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal has optimal performance when performing detection at time unit 1, the terminal may detect the scrambling bit sequence of system message 1 to obtain a scrambling bit sequence index or beam index value 1 and directly or indirectly feed back the scrambling bit sequence index or the beam index value to the base station through the uplink. At this moment, the scrambling bit sequence index corresponds to the beam index. The scrambling bit sequence is configured to scramble and descramble the system message.

### Sub-Example 1.7

It is supposed that the base station may substantially cover an area to be covered by the base station by virtue of 8 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 7 and system message 7 by virtue of beam 7 at time unit 7 or time unit group 7, wherein different synchronization signals may have the same sequence or different sequences. System message n (n=0, 1, . . . , 7) bears an index of a corresponding beam, and the base station indicates the corresponding beam indexes by virtue of spreading code bit sequences in the system messages. Here, there are predefined 8 spreading code bit sequences, and each sequence corresponds to a beam index, as shown in Table 3. A length of each spreading code bit sequence may preferably be a length of a system information bit sequence, and may include or may not include the length of a CRC bit sequence. Table 3 shows a corresponding relationship between a beam index and a spreading code bit sequence. The spreading code bit sequence corresponds to the spreading sequence in the first embodiment to the sixth embodiment.

TABLE 3

| Beam index | Spreading code bit sequence |
|---|---|
| Beam index 0 | Spreading code bit sequence 0 |
| Beam index 1 | Spreading code bit sequence 1 |
| Beam index 2 | Spreading code bit sequence 2 |
| Beam index 3 | Spreading code bit sequence 3 |
| Beam index 4 | Spreading code bit sequence 4 |
| Beam index 5 | Spreading code bit sequence 5 |
| Beam index 6 | Spreading code bit sequence 6 |
| Beam index 7 | Spreading code bit sequence 7 |

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal has optimal performance when performing detection at time unit 1, the terminal may detect spreading code bits of system message 1 to obtain a spreading code bit sequence index or beam index value 1 and directly or indirectly feed back the spreading code bit sequence index or the beam index value to the base station through the uplink. At this moment, the spreading code bit sequence index corresponds to the beam index. The spreading code bit sequence is configured to perform spreading and scrambling processing on the system message.

### Sub-Example 1.8

It is supposed that the base station may substantially cover an area to be covered by the base station by virtue of 4 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 3 and system message 3 by virtue of beam 3 at time unit 3 or time unit group 3, wherein different synchronization signals may have the same sequence or different sequences. System message n (n=0, 1, . . . , 3) bears an index of a corresponding beam, and the base station indicates the corresponding beam indexes by virtue of spreading code bit sequences in the system messages. Here, there are predefined 8 spreading code bit sequences, and each sequence corresponds to a beam index, as shown in Table 4. A length of each spreading code bit sequence may preferably be a length of a system information bit sequence, and may include or may not include the length of a CRC bit sequence.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal has optimal performance when performing detection at time unit 1, the terminal may detect the spreading code bit sequence of system message 1 to obtain a spreading code bit sequence index or beam index value 1 and directly or indirectly feed back the spreading code bit sequence index or the beam index value to the base station through the uplink. At this moment, the spreading code bit sequence index corresponds to the beam index. The spreading code bit sequence is configured to perform spreading and scrambling processing on the system message.

### Sub-Example 1.9

Based on sub-examples 1.1-1.6, system messages may also be spread in a spreading manner to ensure robustness of the system messages, the system messages corresponding to different beam indexes may have different spreading code sequences, different spreading code sequences may be orthogonal or minimally mutually correlated, the terminal is needed to perform de-spreading operation by virtue of corresponding spreading codes when detecting synchronization system messages, and a beam index identification manner may adopt methods in sub-examples 1.1-1.6, or adopt a combination of any two or more of the methods in sub-examples 1.1-1.8 to support more beams.

For example, a bit indication manner may indicate 8 beams with 3 bits, 8*2=16 beams may be indicated if the bit indication manner is combined with a scrambling code manner to design two sequences, and 8*2*2=32 beams may be indicated if two CRC bit sequences are designed in further combination with a CRC bit sequence manner.

Each combination method shall fall within the scope of protection of the disclosure.

When the number of beams sent by the base station is smaller than a predefined maximum number of beams, there may exist a condition that different indexes in the 8 beam indexes correspond to the same beam, as shown in Table 4. Only the base station knows a corresponding relationship between the beam indexes and beam values, the terminal does not know corresponding information, and the base station may find corresponding beams according to corresponding index values. Therefore, the corresponding relationship between the indexes and the practical beams is an implementation method of the base station. Different equipment manufacturers may adopt different corresponding relationships. Each implementation method shall fall within the scope of protection of the disclosure.

TABLE 4

| Beam index contained | |
|---|---|
| in system message | actual beam |
| 0 | Beam 0 |
| 1 | Beam 1 |
| 2 | Beam 2 |
| 3 | Beam 3 |
| 4 | Beam 0 |
| 5 | Beam 1 |
| 6 | Beam 2 |
| 7 | Beam 3 |

### Example 2

Example 2 includes sub-examples 2.1 to 2.9.

It is supposed that a base station may substantially cover an area to be covered by the base station by virtue of N beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal N−1 and system message N−1 by virtue of beam N−1 at time unit N−1 or time unit group N−1, wherein different synchronization signals may have the same sequence or different sequences. System message n (n=0, 1, . . . , N−1) bears an index of the corresponding beam, and the base station indicates the corresponding beam indexes by virtue of M (0≦M≦log₂(N)) bits in the system messages, wherein N is a predefined maximum number of beams supported by the base station.

A terminal detects the synchronization signals and/or the system messages at the time units, and the terminal detects the time units to obtain one or more groups of beam indexes capable of optimizing the receiving performance of the terminal or ensuring optimal received signal quality, and feeds back the corresponding beam indexes to the base station. If the terminal detects that system synchronization signal 1 and/or system message 1 correspond to optimal performance at the time units, the terminal may detect system message 1 to obtain the corresponding beam index and directly or indirectly feed back an index value to the base station through an uplink.

### Sub-Example 2.1

It is supposed that the base station may substantially cover an area to be covered by the base station by virtue of 8 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 7 and system message 7 by virtue of beam 7 at time unit 7 or time unit group 7, wherein different synchronization signals may have the same sequence or different sequences. System message n (n=0, 1, . . . , 7) bears an index of a corresponding beam, and the base station indicates a corresponding beam index by virtue of 3 bits in a system message, wherein 8 is the predefined maximum number of beams supported by the base station.

When the terminal detects the synchronization signal and/or the system message at time unit 0, the terminal detects time unit 0 to obtain one or more groups of beam indexes capable of optimizing the receiving performance of the terminal or ensuring optimal received signal quality, and feeds back the corresponding beam index to the base station. If the terminal detects that synchronization signal 0 and system message 0 correspond to optimal performance at time unit 0, the terminal may detect 3 bits of the system message to obtain beam index value 0 and directly or indirectly feed back the beam index value to the base station through the uplink.

### Sub-Example 2.2

It is supposed that the base station may substantially cover an area to be covered by the base station by virtue of 4 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 3 and system message 3 by virtue of beam 3 at time unit 3 or time unit group 3, wherein different synchronization signals may have the same sequence or different sequences. System message n (n=0, 1, . . . , 3) bears an index of a corresponding beam, and the base station indicates a corresponding beam index by virtue of 3 bits in a system message, wherein 2³=8 is the predefined maximum number of beams supported by the base station.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal detects that synchronization signal 0 and system message 0 correspond to optimal performance at time unit 0, the terminal may detect 3 bits of the system message to obtain beam index value 0 and directly or indirectly feed back the beam index value to the base station through the uplink.

### Sub-Example 2.3

It is supposed that the base station may substantially cover an area to be covered by the base station by virtue of 8 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 7 and system message 7 by virtue of beam 7 at time unit 7 or time unit group 7, wherein different synchronization signals may have the same sequence or different sequences. System message n (n=0, 1, . . . , 7) bears an index of a corresponding beam, and the base station indicates the corresponding beam indexes by virtue of CRC scrambling bit sequences in the system messages. Here, there are predefined 8 CRC scrambling bit sequences, and each sequence corresponds to a beam index, as shown in Table 2. Each CRC scrambling bit sequence may preferably be a sequence which has a length of 16 and consists of a plurality of elements “0” and “1”.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal detects that synchronization signal 0 and system message 0 correspond to optimal performance at time unit 0, the terminal may detect CRC scrambling bits of the system message to obtain an index of a CRC scrambling bit sequence or beam index value 0 and directly or indirectly feed back the index of a CRC scrambling bit sequence or the beam index value to the base station through the uplink. At this moment, an index of a CRC scrambling bit sequence corresponds to a beam index. The CRC scrambling bit sequence is configured to scramble a CRC bit sequence of the system message.

### Sub-Example 2.4

It is supposed that the base station may substantially cover an area to be covered by the base station by virtue of 4 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 3 and system message 3 by virtue of beam 3 at time unit 3 or time unit group 3, wherein different synchronization signals may have the same sequence or different sequences. System message n (n=0, 1, . . . , 3) bears an index of a corresponding beam, and the base station indicates the corresponding beam indexes by virtue of CRC scrambling bit sequences in the system messages. Here, there are predefined 8 CRC scrambling bit sequences, and each sequence corresponds to a beam index, as shown in Table 2. Each CRC scrambling bit sequence may preferably be a sequence which has a length of 16 and consists of a plurality of elements “0” and “1”.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal detects that synchronization signal 0 and system message 0 correspond to optimal performance at time unit 0, the terminal may detect the CRC scrambling bit sequence of the system message to obtain an index of a CRC scrambling bit sequence or beam index value 0 and directly or indirectly feed back the index of a CRC scrambling bit sequence or the beam index value to the base station through the uplink. At this moment, the index of a CRC scrambling bit sequence corresponds to the beam index.

The CRC scrambling bit sequence is configured to scramble a CRC bit sequence of the system message.

### Sub-Example 2.5

It is supposed that the base station may substantially cover an area to be covered by the base station by virtue of 8 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 7 and system message 7 by virtue of beam 7 at time unit 7 or time unit group 7, wherein different synchronization signals may have the same sequence or different sequences. System message n (n=0, 1, . . . , 7) bears an index of a corresponding beam, and the base station indicates the corresponding beam indexes by virtue of scrambling bit sequences in the system messages. Here, there are predefined 8 scrambling bit sequences, and each sequence corresponds to a beam index, as shown in Table 3. A length of each scrambling bit sequence may preferably be a length of a system information bit sequence, and may include or may not include the length of a CRC bit sequence.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal detects that synchronization signal 0 and system message 0 correspond to optimal performance at time unit 0, the terminal may detect scrambling bits of the system message to obtain a scrambling bit sequence index or beam index value 0 and directly or indirectly feed back the scrambling bit sequence index or the beam index value to the base station through the uplink. At this moment, the scrambling bit sequence index corresponds to the beam index. The scrambling bit sequence is configured to scramble a bit sequence of the system message.

### Sub-Example 2.6

It is supposed that the base station may substantially cover an area to be covered by the base station by virtue of 4 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 3 and system message 3 by virtue of beam 3 at time unit 3 or time unit group 3, wherein different synchronization signals may have the same sequence or different sequences. System message n (n=0, 1, . . . , 3) bears an index of a corresponding beam, and the base station indicates the corresponding beam indexes by virtue of scrambling bit sequences in the system messages. Here, there are predefined 8 scrambling bit sequences, and each sequence corresponds to a beam index, as shown in Table 3. A length of each scrambling bit sequence may preferably be a length of a system information bit sequence, and may include or may not include the length of a CRC bit sequence.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal detects that synchronization signal 0 and system message 0 correspond to optimal performance at time unit 0, the terminal may detect the scrambling bit sequence of the system message to obtain a scrambling bit sequence index or beam index value 0 and directly or indirectly feed back the scrambling bit sequence index or the beam index value to the base station through the uplink. The scrambling bit sequence index corresponds to the beam index. The scrambling bit sequence is configured to scramble a bit sequence of the system message.

### Sub-Example 2.7

It is supposed that the base station may substantially cover an area to be covered by the base station by virtue of 8 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 7 and system message 7 by virtue of beam 7 at time unit 7 or time unit group 7, wherein different synchronization signals may have the same sequence or different sequences. System message n (n=0, 1, . . . , 7) bears an index of a corresponding beam, and the base station indicates the corresponding beam indexes by virtue of spreading code bit sequences in the system messages. Here, there are predefined 8 spreading code bit sequences, and each sequence corresponds to a beam index, as shown in Table 4. A length of each spreading code bit sequence may preferably be a length of a system information bit sequence, and may include or may not include the length of a CRC bit sequence.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal detects that synchronization signal 0 and system message 0 correspond to optimal performance at time unit 0, the terminal may detect spreading code bits of the system message to obtain a spreading code bit sequence index or beam index value 0 and directly or indirectly feed back the spreading code bit sequence index or the beam index value to the base station through the uplink. The spreading code bit sequence index corresponds to the beam index. The spreading code bit sequence is configured to spread and scramble a bit sequence of the system message.

### Sub-Example 2.8

It is supposed that the base station may substantially cover an area to be covered by the base station by virtue of 4 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 3 and system message 3 by virtue of beam 3 at time unit 3 or time unit group 3, wherein different synchronization signals may have the same sequence or different sequences. System message n (n=0, 1, . . . , 3) bears an index of a corresponding beam, and the base station indicates the corresponding beam indexes by virtue of spreading code bit sequences in the system messages. Here, there are predefined 8 spreading code bit sequences, and each sequence corresponds to a beam index, as shown in Table 4. A length of each spreading code bit sequence may preferably be a length of a system information bit sequence, and may include or may not include the length of a CRC bit sequence.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal detects that synchronization signal 0 and system message 0 correspond to optimal performance at time unit 0, the terminal may detect the spreading code bit sequence of the system message to obtain a spreading code bit sequence index or beam index value 0 and directly or indirectly feed back the spreading code bit sequence index or the beam index value to the base station through the uplink. The spreading code bit sequence index corresponds to the beam index. The spreading code bit sequence is configured to spread and scramble a bit sequence of the system message.

### Sub-Example 2.9

Based on sub-examples 2.1-2.6, the system messages may also be spread in a spreading manner to ensure robustness of the system messages, the system messages corresponding to different beam indexes may have different spreading code sequences, different spreading code sequences may be orthogonal or minimally mutually correlated, the terminal is needed to perform de-spreading operation by virtue of corresponding spreading codes when detecting the synchronization system messages, and a beam index identification manner may adopt methods in sub-examples 2.1-2.6, or adopt a combination of any two or more of the methods in sub-examples 2.1-2.8 to support more beams.

For example, a bit indication manner may indicate 8 beams with 3 bits, 8*2=16 beams may be indicated if the bit indication manner is combined with a scrambling code manner to design two sequences, and 8*2*2=32 beams may be indicated if two CRC bit sequences are designed in further combination with a CRC bit sequence manner.

Each combination method shall fall within the scope of protection of the disclosure.

When the number of the beams sent by the base station is smaller than the predefined maximum number of beams, there may exist the condition that different indexes in the 8 beam indexes correspond to the same beam, as shown in Table 1. Only the base station knows a corresponding relationship between the beam indexes and beam values, the terminal does not know the corresponding information, and the base station may find corresponding beams according to corresponding index values. Therefore, the corresponding relationship between the indexes and the practical beams is an implementation method of the base station. Different equipment manufacturers may adopt different corresponding relationships. Each implementation method shall fall within the scope of protection of the disclosure.

### Example 3

Example 3 includes sub-examples 3.1-3.9.

It is supposed that a base station may substantially cover an area to be covered by the base station by virtue of N beams. At time unit X, the base station sends synchronization signal 0 and system message 0 by virtue of beam 0, sends synchronization signal 2 and system message 2 by virtue of beam 2, and so on, sends synchronization signal 2n and system message 2n by virtue of beam 2n (wherein n=2-floor((N−1)/2)), wherein floor is a floor function. At time unit Y, the base station sends synchronization signal 1 and system message 1 by virtue of beam 1, sends synchronization signal 3 and system message 3 by virtue of beam 3, and so on, sends synchronization signal 2n+1 and system message 2n+1 by virtue of beam 2n+1 (wherein n=2-floor((N−1)/2)), wherein floor is a floor function. Here, different synchronization signals may have the same sequence or different sequences. System messages 2n and 2n+1 (n=0, 1, . . . , (N−1)/2) bear indexes of the corresponding beams, and the base station indicates the corresponding beam indexes by virtue of M (0≦M≦log₂(N)) bits in the system messages, wherein N is a predefined maximum number of beams supported by the base station.

A terminal detects the synchronization signals and/or the system messages at the time units, and the terminal detects the time units to obtain one or more groups of beam indexes capable of optimizing receiving performance of the terminal or ensuring optimal received signal quality, and feeds back the corresponding beam indexes to the base station. If the terminal detects that system synchronization signal 0 and/or system message 0 correspond to optimal performance at time unit X, the terminal may detect the system message to obtain corresponding beam index 0 and directly or indirectly feed back an index value to the base station through an uplink.

CRC scrambling bit sequences and scrambling bit sequences in example 3 all correspond to the scrambling sequences in the first embodiment to the sixth embodiment; and spreading code bit sequences in example 3 correspond to the spreading sequences in the first embodiment to the sixth embodiment.

### Sub-Example 3.1

It is supposed that the base station may substantially cover an area to be covered by the base station by virtue of 8 beams. At time unit 0, the base station sends synchronization signal 0 and system message 0 by virtue of beam 0, sends synchronization signal 2 and system message 2 by virtue of beam 2, and so on, sends synchronization signal 6 and system message 6 by virtue of beam 6. At time unit 1, the base station sends synchronization signal 1 and system message 1 by virtue of beam 1, sends synchronization signal 3 and system message 3 by virtue of beam 3, and so on, sends synchronization signal 7 and system message 7 by virtue of beam 7.

Here, different synchronization signals may have the same sequence or different sequences. System message n (n=0, 1, . . . , 7) bears an index of a corresponding beam, and the base station indicates a corresponding beam index by virtue of 3 bits in a system message, wherein 8 is the predefined maximum number of beams supported by the base station.

When the terminal detects a synchronization signal and/or a system message at each time unit, the terminal detects multiple time units to obtain one or more groups of beam indexes capable of optimizing the receiving performance of the terminal or ensuring optimal received signal quality, and feeds back the corresponding beam index to the base station. If the terminal detects that synchronization signal 0 and system message 0 correspond to optimal performance at time unit 0, the terminal may detect 3 bits of the system message to obtain beam index value 0 and directly or indirectly feed back the beam index value to the base station through the uplink.

### Sub-Example 3.2

It is supposed that the base station may substantially cover an area to be covered by the base station by virtue of 4 beams. At time unit 0, the base station sends synchronization signal 0 and system message 0 by virtue of beam 0 and sends synchronization signal 2 and system message 2 by virtue of beam 2. At time unit 1, the base station sends synchronization signal 1 and system message 1 by virtue of beam 1 and sends synchronization signal 3 and system message 3 by virtue of beam 3, wherein different synchronization signals may have the same sequence or different sequences. System message n (n=0, 1, . . . , 3) bears an index of a corresponding beam, and the base station indicates a corresponding beam index by virtue of 3 bits in a system message, wherein 2³=8 is the predefined maximum number of beams supported by the base station.

The terminal detects a synchronization signal and/or a system message at each time unit, and the terminal detects the time units to obtain one or more groups of beam indexes capable of optimizing the receiving performance of the terminal or ensuring optimal received signal quality, and feeds back the corresponding beam indexes to the base station. If the terminal detects that synchronization signal 0 and system message 0 correspond to optimal performance at time unit 0, the terminal may detect 3 bits of the system message to obtain beam index value 0 and directly or indirectly feed back the beam index value to the base station through the uplink.

### Sub-Example 3.3

It is supposed that the base station may substantially cover an area to be covered by the base station by virtue of 8 beams. At time unit 0, the base station sends synchronization signal 0 and system message 0 by virtue of beam 0, sends synchronization signal 2 and system message 2 by virtue of beam 2, and so on, the base station sends synchronization signal 6 and system message 6 by virtue of beam 6. At time unit 1, the base station sends synchronization signal 1 and system message 1 by virtue of beam 1, sends synchronization signal 3 and system message 3 by virtue of beam 3, and so on, the base station sends synchronization signal 7 and system message 7 by virtue of beam 7, wherein different synchronization signals may have the same sequence or different sequences. System message n (n=0, 1, . . . , 7) bears an index of a corresponding beam, and the base station indicates the corresponding beam indexes by virtue of CRC scrambling bit sequences in the system messages. Here, there are predefined 8 CRC scrambling bit sequences, and each sequence corresponds to a beam index, as shown in Table 2. Each CRC scrambling bit sequence may preferably be a sequence which has a length of 16 and consists of a plurality of elements “0” and “1”.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal detects that synchronization signal 0 and system message 0 correspond to optimal performance at time unit 0, the terminal may detect CRC scrambling bits of the system message to obtain an index of a CRC scrambling bit sequence or beam index value 0 and directly or indirectly feed back the index of a CRC scrambling bit sequence or the beam index value to the base station through the uplink. At this moment, the index of a CRC scrambling bit sequence corresponds to the beam index. The CRC scrambling bit sequence is configured to scramble a CRC bit sequence of the system message.

### Sub-Example 3.4

It is supposed that the base station may substantially cover an area to be covered by the base station by virtue of 4 beams. At time unit 0, the base station sends synchronization signal 0 and system message 0 by virtue of beam 0 and sends synchronization signal 2 and system message 2 by virtue of beam 2. At time unit 1, the base station sends synchronization signal 1 and system message 1 by virtue of beam 1 and sends synchronization signal 3 and system message 3 by virtue of beam 3, wherein different synchronization signals may have the same sequence or different sequences. System message n (n=0, 1, . . . , 3) bears an index of a corresponding beam, and the base station indicates the corresponding beam indexes by virtue of CRC scrambling bit sequences in the system messages. Here, there are predefined 8 CRC scrambling bit sequences, and each sequence corresponds to a beam index, as shown in Table 2. Each CRC scrambling bit sequence may preferably be a sequence which has a length of 16 and consists of a plurality of elements “0” and “1”.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal detects that synchronization signal 0 and system message 0 correspond to optimal performance at time unit 0, the terminal may detect the CRC scrambling bit sequence of the system message to obtain an index of a CRC scrambling bit sequence or beam index value 0 and directly or indirectly feed back the index of a CRC scrambling bit sequence or the beam index value to the base station through the uplink. At this moment, the index of a CRC scrambling bit sequence corresponds to the beam index.

The CRC scrambling bit sequence is configured to scramble a CRC bit sequence of the system message.

### Sub-Example 3.5

It is supposed that the base station may substantially cover an area to be covered by the base station by virtue of 8 beams. At time unit 0, the base station sends synchronization signal 0 and system message 0 by virtue of beam 0, sends synchronization signal 2 and system message 2 by virtue of beam 2, and so on, the base station sends synchronization signal 6 and system message 6 by virtue of beam 6. At time unit 1, the base station sends synchronization signal 1 and system message 1 by virtue of beam 1, sends synchronization signal 3 and system message 3 by virtue of beam 3, and so on, the base station sends synchronization signal 7 and system message 7 by virtue of beam 7, wherein different synchronization signals may have the same sequence or different sequences. System message n (n=0, 1, . . . , 7) bears an index of a corresponding beam, and the base station indicates the corresponding beam indexes by virtue of scrambling bit sequences in the system messages. Here, there are predefined 8 scrambling bit sequences, and each sequence corresponds to a beam index, as shown in Table 3. A length of each scrambling bit sequence may preferably be a length of a system information bit sequence, and may include or may not include the length of a CRC bit sequence.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal detects that synchronization signal 0 and system message 0 correspond to optimal performance at time unit 0, the terminal may detect scrambling bits of the system message to obtain a scrambling bit sequence index or beam index value 0 and directly or indirectly feed back the scrambling bit sequence index or the beam index value to the base station through the uplink. At this moment, the scrambling bit sequence index corresponds to the beam index. The scrambling bit sequence is configured to scramble a bit sequence of the system message.

### Sub-Example 3.6

It is supposed that the base station may substantially cover an area to be covered by the base station by virtue of 4 beams. At time unit 0, the base station sends synchronization signal 0 and system message 0 by virtue of beam 0 and sends synchronization signal 2 and system message 2 by virtue of beam 2. At time unit 1, the base station sends synchronization signal 1 and system message 1 by virtue of beam 1 and sends synchronization signal 3 and system message 3 by virtue of beam 3, wherein different synchronization signals may have the same sequence or different sequences. System message n (n=0, 1, . . . , 3) bears an index of a corresponding beam, and the base station indicates the corresponding beam indexes by virtue of scrambling bit sequences in the system messages. Here, there are predefined 8 scrambling bit sequences, and each sequence corresponds to a beam index, as shown in Table 3. A length of each scrambling bit sequence may preferably be a length of a system information bit sequence, and may include or may not include the length of a CRC bit sequence.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal detects that synchronization signal 0 and system message 0 correspond to optimal performance at time unit 0, the terminal may detect the scrambling bit sequence of the system message to obtain a scrambling bit sequence index or beam index value 0 and directly or indirectly feed back the scrambling bit sequence index or the beam index value to the base station through the uplink. The scrambling bit sequence index corresponds to the beam index. The scrambling bit sequence is configured to scramble a bit sequence of the system message.

### Sub-Example 3.7

It is supposed that the base station may substantially cover an area to be covered by the base station by virtue of 8 beams. At time unit 0, the base station sends synchronization signal 0 and system message 0 by virtue of beam 0, sends synchronization signal 2 and system message 2 by virtue of beam 2, and so on, the base station sends synchronization signal 6 and system message 6 by virtue of beam 6. At time unit 1, the base station sends synchronization signal 1 and system message 1 by virtue of beam 1, sends synchronization signal 3 and system message 3 by virtue of beam 3, and so on, the base station sends synchronization signal 7 and system message 7 by virtue of beam 7, wherein different synchronization signals may have the same sequence or different sequences. System message n (n=0, 1, . . . , 7) bears an index of a corresponding beam, and the base station indicates the corresponding beam indexes by virtue of spreading code bit sequences in the system messages. Here, there are predefined 8 spreading code bit sequences, and each sequence corresponds to a beam index, as shown in Table 4. A length of each spreading code bit sequence may preferably be a length of a system information bit sequence, and may include or may not include the length of a CRC bit sequence.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal detects that synchronization signal 0 and system message 0 correspond to optimal performance at time unit 0, the terminal may detect spreading code bits of the system message to obtain a spreading code bit sequence index or beam index value 0 and directly or indirectly feed back the spreading code bit sequence index or the beam index value to the base station through the uplink. The spreading code bit sequence index corresponds to the beam index. The spreading code bit sequence is configured to spread and scramble a bit sequence of the system message.

### Sub-Example 3.8

It is supposed that the base station may substantially cover an area to be covered by the base station by virtue of 4 beams. The base station sends synchronization signal 0 and system message 0 by virtue of beam 0 at time unit 0 or time unit group 0, the base station sends synchronization signal 1 and system message 1 by virtue of beam 1 at time unit 1 or time unit group 1, and so on, the base station sends synchronization signal 3 and system message 3 by virtue of beam 3 at time unit 3 or time unit group 3, wherein different synchronization signals may have the same sequence or different sequences. System message n (n=0, 1, . . . , 3) bears an index of a corresponding beam, and the base station indicates the corresponding beam indexes by virtue of spreading code bit sequences in the system messages. Here, there are predefined 8 spreading code bit sequences, and each sequence corresponds to a beam index, as shown in Table 4. A length of each spreading code bit sequence may preferably be a length of a system information bit sequence, and may include or may not include the length of a CRC bit sequence.

The terminal detects a synchronization signal and/or a system message at each time unit, and the terminal detects multiple time units to obtain one or more groups of beam indexes capable of optimizing the receiving performance of the terminal or ensuring optimal received signal quality, and feeds back the corresponding beam indexes to the base station. If the terminal detects that synchronization signal 0 and system message 0 correspond to optimal performance at time unit 0, the terminal may detect the spreading code bit sequence of the system message to obtain a spreading code bit sequence index or beam index value 0 and directly or indirectly feed back the spreading code bit sequence index or the beam index value to the base station through the uplink. The spreading code bit sequence index corresponds to the beam index. The spreading code bit sequence is configured to spread and scramble a bit sequence of the system message.

### Sub-Example 3.9

Based on sub-examples 3.1-3.6, the system messages may also be spread in a spreading manner to ensure robustness of the system messages, the system messages corresponding to different beam indexes may have different spreading code sequences, different spreading code sequences may be orthogonal or minimally mutually correlated, the terminal is needed to perform de-spreading operation by virtue of corresponding spreading codes when detecting the synchronization system messages, and a beam index identification manner may adopt methods in sub-examples 3.1-3.6, or adopt a combination of any two or more of the methods in sub-examples 3.1-3.8 to support more beams.

For example, a bit indication manner may indicate 8 beams with 3 bits, 8*2=16 beams may be indicated if the bit indication manner is combined with a scrambling code manner to design two sequences, and 8*2*2=32 beams may be indicated if two CRC bit sequences are designed in further combination with a CRC bit sequence manner.

Each combination method shall fall within the scope of protection of the disclosure.

When the number of the beams sent by the base station is smaller than the predefined maximum number of beams, there may exist the condition that different indexes in the 8 beam indexes correspond to the same beam, as shown in Table 4. Only the base station knows a corresponding relationship between the beam indexes and beam values, the terminal does not know the corresponding information, and the base station may find corresponding beams according to corresponding index values. Therefore, the corresponding relationship between the indexes and the practical beams is an implementation method of the base station. Different equipment manufacturers may adopt different corresponding relationships. Each implementation method shall fall within the scope of protection of the disclosure.

Only the condition that two time units bear multiple beams is described in the example, and in a practical application, multiple time units may bear multiple beams, each time unit may bear multiple beams and multiple time units bear all beams needed to be born.

The system messages indicating different beams may be scrambled by adopting different CRC scrambling bit sequences, scrambling sequences and spreading code sequences.

The CRC scrambling bit sequences in the system messages refer to scrambling the CRC bit sequences of the system messages with the CRC scrambling bit sequences, and the base station scrambles the CRC bit sequences of the system messages bearing different beam index information by adopting different CRC scrambling bit sequences.

The scrambling bit sequences in the system messages refer to scrambling the bit sequences of the system messages with the CRC scrambling bit sequences, and for the system messages including the beam indexes, the base station scrambles the system message bit sequences corresponding to the system messages by adopting the scrambling bit sequences, wherein the bit sequences of the system messages may include and may not include the CRC bit sequences.

The spreading code bit sequences in the system messages refer to spreading the bit sequences of the system messages, and for the system messages bearing different beam index information, the base station spreads the system message bit sequences by adopting the spreading code bit sequences, wherein the bit sequences of the system messages may include and may not include the CRC bit sequences.

The CRC scrambling bit sequences and scrambling bit sequences in example 3 correspond to the scrambling sequences in the first embodiment to the sixth embodiment;

and the spreading code bit sequences in example 3 correspond to the spreading sequences in the first embodiment to the sixth embodiment.

### Example 4

In a practical system, a base station may adopt different transmitting power for different beams to reduce transmitting power of the base station and fulfil the aim of saving energy. For example: for a 3-Dimensional (3D) antenna base station, in a vertical direction, a beam with a large downward inclination angle has smaller coverage, so that lower transmitting power is adopted; but for a beam with a small downlink inclination angle and large coverage, higher transmitting power is adopted. A terminal is needed to distinguish beams adopting different power during beam selection, so that the base station may send downlink data to the terminal by adopting as much low as possible power.

The base station is required to add power indication information or power offset indication information into a system message and notify a power value of a beam for sending the system message to the terminal, and if the terminal finds that a peak difference between two beams is lower than a threshold value when performing beam selection operation, the terminal may calculate the peak difference of the two beams under the condition of the same power according to the power indication information or the power offset indication information, preferably selects the beam with the highest peak and feeds back its index.

A selection algorithm for the terminal may be an implementation problem of a terminal manufacturer, and the idea mainly protected by the embodiment of the disclosure is that the system message of the base station includes the beam index, and also includes the power indication information or power offset indication information of the beam.

In a practical application, one base station may send multiple beams at the same time unit, the multiple beams being the same or different, and may also send only one beam at the same time unit. No matter which manner is adopted by the base station, the terminal obtaining related information of a beam index through related information of a system message by virtue of the inventive idea of the disclosure shall fall within the scope of protection of the disclosure. In the disclosure, the terminal feeds back the index to ensure integrity of an implementation solution only, and whether the terminal practically feeds back the index or not does not form any limit to the inventive idea.

There are many methods for the terminal to detect an optimal sequence, which may all be detection implementation methods. For example, a sequence-correlated method is adopted to select a sequence index with the highest correlation value for feedback. Different sequence indexes may be selected according to different criterions, and there are no limits to the inventive idea of the disclosure. Any detection method shall fall within the scope of protection of the disclosure as long as one or more optimal values may be calculated and corresponding index values may be obtained.

The embodiment of the disclosure further provides a computer storage medium, in which computer-executable instructions are stored, the computer-executable instructions being configured to execute the methods in any of the abovementioned method embodiments.

Each unit may be implemented by a CPU, Digital Signal Processor (DSP) or Field-Programmable Gate Array (FPGA) in electronic equipment.

Those skilled in the art should know that the embodiments of the disclosure may be provided as a method, a system or a computer program product. Therefore, the disclosure may adopt a form of pure hardware embodiment, pure software embodiment and combined software and hardware embodiment. Moreover, the disclosure may adopt a form of computer program product implemented on one or more computer-available storage media (including, but not limited to, a disk memory, an optical memory and the like) including computer-available program codes.

The disclosure is described with reference to flowcharts and/or block diagrams of the method, equipment (system) and computer program product according to the embodiment of the disclosure. It should be understood that each flow and/or block in the flowcharts and/or the block diagrams and combinations of the flows and/or blocks in the flowcharts and/or the block diagrams may be implemented by computer program instructions. These computer program instructions may be provided for a universal computer, a dedicated computer, an embedded processor or a processor of other programmable data processing equipment to generate a machine, so that a device for realizing a function specified in one flow or more flows in the flowcharts and/or one block or more blocks in the block diagrams is generated by the instructions executed through the computer or the processor of the other programmable data processing equipment.

These computer program instructions may also be stored in a computer-readable memory capable of guiding the computer or the other programmable data processing equipment to work in a specific manner, so that a product including an instruction device may be generated by the instructions stored in the computer-readable memory, the instruction device realizing the function specified in one flow or many flows in the flowcharts and/or one block or many blocks in the block diagrams.

These computer program instructions may further be loaded onto the computer or the other programmable data processing equipment, so that a series of operating steps are executed on the computer or the other programmable data processing equipment to generate processing implemented by the computer, and steps for realizing the function specified in one flow or many flows in the flowcharts and/or one block or many blocks in the block diagrams are provided by the instructions executed on the computer or the other programmable data processing equipment.

The above are only the preferred embodiments of the disclosure and not intended to limit the scope of patent of the disclosure.

1. A method for determining a downlink beam, comprising:
sending at least one beam, wherein each of the at least one beam respectively bears a beam index corresponding to each of the at least one beam;
receiving a fed-back beam index; and
selecting a beam corresponding to the fed-back beam index as a downlink beam.

2. The method according to claim 1, further comprising:
bearing the beam index on the beam.

3. The method according to claim 2, wherein bearing the beam index on the beam comprises:
directly bearing a first sequence corresponding to the beam index on the beam;
or
pre-processing a second sequence to form a third sequence by virtue of a first processing sequence, wherein the second sequence comprises a system message sequence and/or a check sequence, the system message sequence corresponds to a system message, the check sequence corresponds to a check code of the system message, the first processing sequence corresponds to the beam index, the beam index corresponds to at least one first processing sequence and different beam indexes correspond to different first processing sequences; and
bearing the third sequence on the beam.

4. The method according to claim 3, wherein directly bearing the first sequence corresponding to the beam index on the beam comprises:
bearing the first sequence, as a part of the system message sequence, corresponding to the beam index on the beam,
wherein the system message sequence corresponds to the system message.

5. The method according to claim 3, wherein
the first processing sequence is a scrambling sequence; and pre-processing the second sequence to form the third sequence by virtue of the first processing sequence comprises:
performing scrambling processing on the system message sequence and/or the check sequence to form the third sequence by virtue of the scrambling sequence;
or,
the first processing sequence is a spreading sequence; the second sequence comprises the system message sequence and the check sequence; and pre-processing the second sequence to form the third sequence using the first processing sequence comprises:
performing spreading processing on the system message sequence and the check sequence to form the third sequence by virtue of the spreading sequence.

6. (canceled)

7. The method according to claim 1, wherein
each of the at least one beam respectively bears power indication information or power offset indication information of each of the at least one beam, wherein the power indication information or the power offset indication information is configured to provide a basis for beam selection; and
before sending the beam, the method further comprises bearing the power indication information or the power offset indication information on each of the at least one beam.

8. A method for determining a downlink beam, comprising:
receiving at least one beam, wherein each of the at least one beam respectively bears a beam index corresponding to each of the at least one beam;
selecting a beam matching with a pre-stored beam selection strategy from the received at least one beam;
extracting a beam index born on the selected beam; and
sending the beam index.

9. The method according to claim 8, wherein extracting the beam index comprises:
directly extracting a first sequence corresponding to the beam index from the beam;
or
extracting a third sequence from the beam;
performing preset processing on the third sequence to acquire a second sequence by virtue of a second processing sequence which is pre-stored, wherein the second sequence comprises a system message sequence and/or a check sequence, the system message sequence corresponds to a system message and the check sequence corresponds to a check code of the system message; and
determining the beam index according to the second processing sequence corresponding to the second sequence obtained by preset processing,
wherein the second processing sequence corresponds to only one beam index, and the one beam index corresponds to at least one second processing sequence.

10. The method according to claim 9, wherein directly extracting the first sequence corresponding to the beam index from the beam comprises:
extracting the first sequence corresponding to the system message sequence from the beam,
wherein the system message sequence corresponds to the system message.

11. The method according to claim 9, wherein
the second processing sequence is a descrambling sequence;
performing preset processing on the third sequence to acquire the second sequence by virtue of the second processing sequence which is pre-stored comprises:
performing descrambling processing on the third sequence to acquire the second sequence by virtue of the descrambling sequence which is pre-stored; and
determining the beam index according to the second processing sequence corresponding to the second sequence obtained by preset processing comprises:
determining the beam index according to the descrambling sequence corresponding to the second sequence obtained after descrambling processing;
or,
the second processing sequence is a spreading sequence; the second sequence comprises the system message sequence and the check sequence;
performing preset processing on the third sequence to acquire the second sequence by virtue of the second processing sequence which is pre-stored comprises:
performing de-spreading processing on the third sequence to acquire the system message sequence by virtue of the spreading sequence which is pre-stored; and
determining the beam index according to the second processing sequence corresponding to the second sequence obtained by preset processing comprises:
determining the beam index according to the spreading sequence corresponding to the second sequence obtained after de-spreading processing.

12. (canceled)

13. The method according to claim 8, wherein the pre-stored beam selection strategy is a strategy that received signal quality is optimal or a strategy that received signal quality is higher than a threshold value.

14. The method according to claim 8, wherein selecting the beam matching with the pre-stored beam selection strategy from the received at least one beam comprises:
extracting, from the at least one beam, power indication information or power offset indication information of the at least one beam, and acquiring transmitting power of the at least one beam; and
when a received signal quality difference of at least two beams is smaller than a first threshold value or received quality of at least two beams is higher than a second threshold value, selecting the beam with minimum transmitting power.

15. (canceled)

16. A device for determining a downlink beam, comprising:
a first sending unit, configured to send at least one beam, each of the at least one beam respectively bearing a beam index corresponding to each of the at least one beam;
a first receiving unit, configured to receive a fed-back beam index; and
a first selection unit, configured to select a beam corresponding to the fed-back beam index as a downlink beam.

17. The device according to claim 16, further comprising:
a bearing unit, configured to bear the beam index on the beam.

18. The device according to claim 17, wherein the bearing unit is configured to:
directly bear a first sequence corresponding to the beam index on the beam;
or
pre-process a second sequence to form a third sequence by virtue of a first processing sequence, wherein the second sequence comprises a system message sequence and/or a check sequence, the system message sequence corresponds to a system message, the check sequence corresponds to a check code of the system message, the first processing sequence corresponds to the beam index, the beam index corresponds to at least one first processing sequence and different beam indexes correspond to different first processing sequences; and
bear the third sequence on the beam.

19. The device according to claim 18, wherein, when the bearing unit is configured to directly bear the first sequence corresponding to the beam index on the beam, the bearing unit is configured to bear the first sequence, as a part of the system message sequence, corresponding to the beam index on the beam,
wherein the system message sequence corresponds to the system message.

20. The device according to claim 18, wherein the first processing sequence is a scrambling sequence; and the bearing unit is configured to perform scrambling processing on the system message sequence and/or the check sequence to form the third sequence by virtue of the scrambling sequence, and bear the third sequence on the beam;
or
the first processing sequence is a spreading sequence; the second sequence comprises the system message sequence and the check sequence; and the bearing unit is configured to perform spreading processing on the system message sequence and the check sequence to form the third sequence by virtue of the spreading sequence, and bear the third sequence on the beam.

21. (canceled)

22. The device according to claim 16, wherein
each of the at least one beam respectively bears power indication information or power offset indication information of each of the at least one beam;
the power indication information or the power offset indication information is configured to provide a basis for beam selection; and
the bearing unit is further configured to bear the power indication information or the power offset indication information on each of the at least one beam.

23. A device for determining a downlink beam, comprising:
a second receiving unit, configured to receive at least one beam, wherein each of the at least one beam respectively bears a beam index corresponding to each of the at least one beam;
a second selection unit, configured to select a beam matching with a pre-stored beam selection strategy from the received at least one beam;
an extraction unit, configured to extract a beam index born on the selected beam; and
a second sending unit, configured to send the beam index.

24. The device according to claim 23, wherein the extraction unit is configured to:
directly extract a first sequence corresponding to the beam index from the beam;
or
extract a third sequence from the beam;
perform preset processing on the third sequence to acquire a second sequence by virtue of a second processing sequence which is pre-stored, wherein the second sequence comprises a system message sequence and/or a check sequence, the system message sequence corresponds to a system message and the check sequence corresponds to a check code of the system message; and
determine the beam index according to the second processing sequence corresponding to the second sequence obtained by preset processing,
wherein the second processing sequence corresponds to only one beam index, and the one beam index corresponds to at least one second processing sequence.

25. The device according to claim 24, wherein, when the extraction unit is configured to directly extract the first sequence corresponding to the beam index from the beam, the extraction unit is configured to extract the first sequence corresponding to the system message sequence from the beam, wherein the system message sequence corresponds to the system message.

26. The device according to claim 23, wherein the second processing sequence is a descrambling sequence; and the extraction unit is configured to perform descrambling processing on the third sequence to acquire the second sequence by virtue of the descrambling sequence which is pre-stored, and determine the beam index according to the descrambling sequence corresponding to the second sequence obtained after descrambling processing;
or
the second processing sequence is a spreading sequence; the second sequence comprises the system message sequence and the check sequence; and the extraction unit is configured to perform de-spreading processing on the third sequence to acquire the second sequence by virtue of the spreading sequence which is ore-stored, and determine the beam index according to the spreading sequence corresponding to the second sequence obtained after de-spreading processing.

27. (canceled)

28. The device according to claim 23, wherein the pre-stored beam selection strategy is a strategy that received signal quality is optimal or a strategy that received signal quality is higher than a threshold value.

29. The device according to claim 23, wherein the second selection unit is configured to extract, from the at least one beam, power indication information or power offset indication information of the at least one beam, acquire transmitting power of the beams, and when a received signal quality difference of at least two beams is smaller than a first threshold value or received quality of at least two beams is higher than a second threshold value, select the beam with minimum transmitting power.

30. (canceled)

31. A computer storage medium, having stored therein computer-executable instructions configured to execute the method according to claim 1.
